(19) United States
(12) Patent Application Publication
(10) Pub. No.: US 2005/0222289 A1
(43) Pub. Date: Oct. 6, 2005

(54) Process and apparatus for producing rigid polyurethane foam

(76) Inventor: Edward A. Miller, Coraopolis, PA (US)

Correspondence Address: BAYER MATERIAL SCIENCE LLC, 100 BAYER ROAD, PITTSBURGH, PA, 15205, US

(21) Appl. No.: 10/818,108

(22) Filed: Apr. 5, 2004

(51) Int. Cl. C08G 18/00

(52) U.S. Cl. 521/155

(57) ABSTRACT

The present invention provides an apparatus and a process for producing a rigid polyurethane foam involving spraying a mixture containing at least one isocyanate and at least one isocyanate reactive compound onto a supporting surface through a plurality of flat spray nozzles arranged over the supporting surface such that foam cells in the rigid polyurethane foam have substantially uniform dimensional stability and compressive strength throughout the foam. The rigid polyurethane foams of the invention are useful in a wide range of applications such as roofing, sheathing, metal panels such as used in garage doors and the like.

### FIELD OF THE INVENTION

The present invention relates in general to polyurethane foam production, and more specifically, to a process and apparatus for producing a rigid polyurethane foam with few or no knit lines.

### BACKGROUND OF THE INVENTION

Typically, on continuous lamination lines that produce roofing and sheathing polyurethane foam products, the foaming operation uses some type of multi-stream laydown. Most laminators use two or three mixheads and, depending on the type and thickness of the product, from two to five foam streams coming out of each head. Where these foam streams flow together to form the board, the edges create a line in the board which is known in the art as a “knit line”. There may be as many as four to eight knit lines in each board depending on the type and thickness of product. At the knit lines, the cells of the foam are normally weaker due to the orientation of the cells. This results in poor foam dimensional stability and lower compressive strength in these areas. The knit lines may also result in a wavy surface on the face of the boards, which is the primary complaint of the contractors using the product. A number of patents have been directed towards reducing or eliminating knit lines, with varying degrees of success.

U.S. Pat. No. 3,927,162, issued to Stalter, Sr., teaches a method of producing polyurethane foam by distributing a liquid polyurethane reaction mixture containing an organic polyisocyanate reactive hydrogen containing polymeric material and a blowing agent under pressure of 0.5 to 200 pounds per square inch above atmospheric pressure and distributing the polyurethane reaction mixture in a fan-like planular pattern across at least part of the mold cavity while moving the mold and pouring head relative to each other.

Gilbert, in U.S. Pat. No. 4,156,041, discloses an apparatus for continuously depositing a liquid reaction mixture onto continuously moving sheet material. The apparatus is said to comprise a delivery device having one or more distributors attached to a carriage capable of traversing the moving sheet material in a reciprocating motion, wherein the distributor or distributors are feedably connected to one or more stationary mixing heads.

U.S. Pat. Nos. 4,165,211 and 4,216,181, both issued to Ebeling et al., teach a process and an apparatus for applying a layer of liquid, foamable reaction mixture to a continuously moving support, such as for the production of foam blocks or foam sandwich panels having a thick foam core.

Ahmad in U.S. Pat. No. 4,278,045, discloses a dispensing cone for dispensing foamable material onto a moving surface comprises a chamber having a plurality of discharge ports which are generally cylindrical and have nonparallel longitudinal axes. The discharge ports are generally coplanar in a plane generally parallel to the direction of movement of the moving surface. The discharge cone can be oscillated across the width of the moving surface.

Garcia et al. in U.S. Pat. No. 5,037,580 and RE 35,447, disclose compositions for producing foamed products which include filler and/or pigment additives and blowing agents which enhance the strength of “weld lines” which are produced when the compositions are molded. The products produced from the compositions are said to have a weld line that demonstrate superior strengths as compared to similar foamed products which do not utilize the particular blowing agents.

None of these patents has described a satisfactory way of reducing or eliminating knit lines at the line speeds typically employed by today's polyurethane foam board manufacturers. Therefore, a need exists in the art for a better way of reducing or eliminating knit lines in polyurethane boards.

### SUMMARY OF THE INVENTION

Accordingly, the present invention greatly reduces or eliminates knit lines in rigid polyurethane foam boards by providing a process and apparatus employing flat spray nozzles to deliver the polyurethane foam mixture to a supporting surface. With flat spray nozzles, the knit lines and effects associated therewith, are minimized or eliminated by creating a substantially full liquid wet-out of the foam chemicals on the supporting surface. Further, the cells of the foam produced by flat spray nozzles have a more regular, uniform, circular shape, resulting in improved dimensional stability and compressive strength in the boards. The flat spray nozzles also help make a flatter board.

These and other advantages and benefits of the present invention will be apparent from the Detailed Description of the Invention herein below.

### BRIEF DESCRIPTION OF THE FIGURES

The present invention will now be described for purposes of illustration and not limitation in conjunction with the figures, wherein:

FIGS. 1a and 1b are micrographs of a cross section taken through rigid polyurethane foam boards produced by the standard multi-stream process;

FIGS. 2a and 2b are micrographs of a cross section taken through rigid polyurethane foam boards produced according to the present invention;

FIG. 3 depicts the inventive process which greatly reduces or eliminates knit lines;

FIG. 4 shows the inventive process from another perspective; and

FIG. 5 illustrates the standard multi-stream process.

### DETAILED DESCRIPTION OF THE INVENTION

The present invention will now be described for purposes of illustration and not limitation. Except in the operating examples, or where otherwise indicated, all numbers expressing quantities, percentages, OH numbers, functionalities and so forth in the specification are to be understood as being modified in all instances by the term “about.”

The present invention provides a process of producing a rigid polyurethane foam involving spraying a mixture containing at least one isocyanate and at least one isocyanate reactive compound onto a supporting surface through a plurality of flat spray nozzles arranged over the supporting surface such that foam cells in the rigid polyurethane foam have substantially uniform dimensional stability and compressive strength throughout the foam.

The present invention also provides a rigid polyurethane foam producing apparatus made of a plurality of flat spray nozzles, one or more mix heads, a plurality of reservoirs, at least one of which contains an isocyanate and at least another one of which contains an isocyanate reactive compound and a supporting surface, wherein the plurality of flat spray nozzles are connected to the one or more mix heads which are connected to the plurality of reservoirs and the plurality of flat spray nozzles are arranged over the supporting surface such that substantially full liquid wet-out occurs during polyurethane foam production.

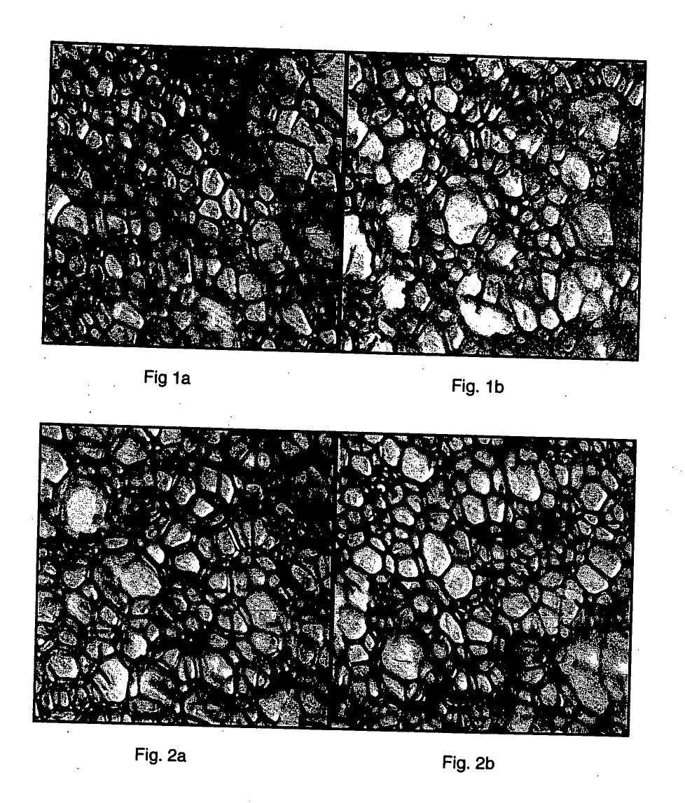

The inventor herein has found that the shape and orientation of the cells are important to the overall properties exhibited by a rigid polyurethane foam. Spray nozzles commonly used in foam board production create irregularly-shaped cells, such as those depicted in FIGS. 1a and 1b, which can be oriented in different directions in the foam. This results in a foam having variable, inconsistent properties, particularly at the knit lines which are created at the edges of the liquid. The present invention employs a plurality of flat spray nozzles arranged to provide substantially full liquid wet-out and thus greatly reduces or eliminates knit lines in the resultant board. By substantially full liquid wet-out, the inventor herein means at least 95% liquid foam laydown across the width of the product. As the foam cells produced by these flat spray nozzles are more regular and substantially circular (see FIGS. 2a and 2b), fewer orientations of the cells are possible. Thus, the resulting foam exhibits more consistent physical properties throughout its length and width. The flat spray nozzles have the added benefits of permitting increased line speeds on foam producing machines and producing flatter boards.

Flat spray nozzles come in various sizes and are available from a variety of manufacturers. Flat spray nozzles typically are used to spray air or water and are commonly used in such applications as spray agitation, spraying eliminator plates, cooling conveyor belts, foam knockdown, film washing, water curtains and fire protection. A flat spray nozzle distributes the liquid as a flat- or sheet-type spray and uses an elliptical orifice, or a round orifice tangential to a deflector surface to produce a flat spray pattern. The correct size of flat spray nozzle used is dependent on the thickness of the product and the total output of the foam. Also the flat spray nozzle size is determined by the width of the fan that is desired, the number of heads used, and the number of fans needed to make the product. Such nozzles have not, to the best of the inventor's knowledge, heretofore been used to spray as viscous a liquid as a polyurethane foam composition.

In the manufacture of rigid polyisocyanurate foams, according to the present invention, two preformulated components may used, commonly called the A-component (also called the A-side) and the B-component (or B-side). Typically, the A-component contains the isocyanate compound which is reacted with the polyol of the B-component to form the foam, with the remainder of the foam-forming ingredients distributed in these two components or in yet another component or components.

Any organic polyisocyanate can be employed in the preparation of the rigid polyisocyanurate foams according to the present invention including aromatic, aliphatic and cycloaliphatic polyisocyanates and combinations thereof. Suitable polyisocyanates are described, for example, in U.S. Pat. Nos. 4,795,763, 4,065,410, 3,401,180, 3,454,606, 3,152,162, 3,492,330, 3,001,973, 3,394,164 and 3,124,605, the entire contents of which are incorporated herein by reference thereto.

Examples of such polyisocyanates are the diisocyanates such as m-phenylene diisocyanate, toluene-2,4-diisocyanate, toluene-2,6-diisocyanate, mixtures of 2,4- and 2,6-toluene diisocyanate, hexamethylene-1,6-diisocyanate, tetramethylene-1,4-diisocyanate, cyclohexane-1,4-diisocyanate, hexahydrotoluene 2,4- and 2,6-diisocyanate, naphthalene-1,5-diisocyanate, diphenyl methane-4,4′-diisocyanate, 4,4′-diphenylenediisocyanate, 3,3′-dimethoxy-4,4′-biphenyl-diisocyanate, 3,3′-dimethyldiphenylmethane-4,4′-diisocyanate; the triisocyanates such as 4,4′,4′-triphenylmethane-triisocyanate, polymethylenepolyphenyl isocyanate, toluene-2,4,6-triisocyanate; and the tetraisocyanates such as 4,4′-dimethyldiphenylmethane-2,2′,5,5′-tetraisocyanate.

Prepolymers may also be employed in the preparation of the foams of the present invention. Prepolymers may be prepared by reacting an excess of organic polyisocyanate or mixtures thereof with a minor amount of an active hydrogen-containing compound as determined by the well-known Zerewitinoff test, as described by Kohler in “Journal of the American Chemical Society,” 49, 3181(1927). These compounds and their methods of preparation are well known in the art. The use of any one specific active hydrogen compound is not critical, any such compound can be employed in the practice of the present invention.

Preferred isocyanates used according to the present invention include MONDUR 489 (available from Bayer), RUBINATE 1850 (available from Huntsman), LUPRINATE M70R (available from BASF) and PAPI 580 (available from Dow). Isocyanate indices greater than 200 are preferred, particularly from 225 to 325.

Any of the known organic isocyanate reactive compounds may be used to produce foams in accordance with the present invention. Polyols containing at least two isocyanate-reactive hydrogen atoms and having a hydroxyl (OH) number of from 200 to 650, more preferably from 220 to 350 are particularly suitable. The isocyanate reactive compound is used in a quantity sufficient to allow the preparation of low friability, dimensionally stable and strong foams. Preferred as isocyanate-reactive compounds are the polyester and polyether polyols. Such polyester and polyether polyols are described, for example, in U.S. Pat. No. 4,795,763, which is incorporated in its entirety herein by reference thereto. The molecular weight of such isocyanate-reactive materials are determined in accordance with the end group analysis method generally used by those skilled in the art and represent a number average molecular weight.

The polyester polyols useful in the invention can be prepared by known procedures from a polycarboxylic acid or acid derivative, such as an anhydride or ester of the polycarboxylic acid, and a polyhydric alcohol. The acids and/or the alcohols may be used as mixtures of two or more compounds in the preparation of the polyester polyols.

The polycarboxylic acid component, which is preferably dibasic, may be aliphatic, cycloaliphatic, aromatic and/or heterocyclic and may optionally be substituted, for example, by halogen atoms, and/or may be unsaturated. Examples of suitable carboxylic acids and derivatives thereof for the preparation of the polyester polyols include: oxalic acid; malonic acid; succinic acid; glutaric acid; adipic acid; pimelic acid; suberic acid; azelaic acid; sebacic acid; phthalic acid; isophthalic acid; trimellitic acid; terephthalic acid; phthalic acid anhydride; tetrahydrophthalic acid anhydride; pyromellitic dianhydride; hexahydrophthalic acid anhydride; tetrachlorophthalic acid anhydride; endomethylene tetrahydrophthalic acid anhydride; glutaric acid anhydride; maleic acid; maleic acid anhydride; fumaric acid; dibasic and tribasic unsaturated fatty acids optionally mixed with monobasic unsaturated fatty acids, such as oleic acid; terephthalic acid dimethyl ester and terephthalic acid-bis-glycol ester.

Any suitable polyhydric alcohol may be used in preparing the polyester polyols. The polyols can be aliphatic, cycloaliphatic, aromatic and/or heterocyclic, and are preferably selected from the group consisting of diols, triols and tetrols. Aliphatic dihydric alcohols having no more than 20 carbon atoms are highly satisfactory. The polyols optionally may include substituents which are inert in the reaction, for example, chlorine and bromine substituents, and/or may be unsaturated. Suitable amino alcohols, such as, for example, monoethanolamine, diethanolamine, triethanolamine, or the like may also be used. Moreover, the polycarboxylic acid(s) may be condensed with a mixture of polyhydric alcohols and amino alcohols.

Examples of suitable polyhydric alcohols include, but are not limited to, ethylene glycol; propylene glycol-(1,2) and -(1,3); butylene glycol-(1,4) and -(2,3); hexane diol-(1,6); octane diol-(1,8); neopentyl glycol; 1,4-bis-hydroxymethyl cyclohexane; 2-methyl-1,3-propane diol; glycerin; trimethylolpropane; trimethylolethane; hexane triol-(1,2,6); butane triol-(1,2,4); pentaerythritol; quinitol; mannitol; sorbitol; formitol; α-methyl-glucoside; diethylene glycol; triethylene glycol; tetraethylene glycol and higher polyethyleneglycols; dipropylene glycol and higher polypropylene glycols as well as dibutylene glycol and higher polybutylene glycols. Particularly preferred are oxyalkylene glycols, such as diethylene glycol, dipropylene glycol, triethylene glycol, tripropylene glycol, tetraethylene glycol, tetrapropylene glycol, trimethylene glycol and tetramethylene glycol.

Polyether polyols useful according to the present invention include the reaction products of a polyfunctional active hydrogen initiator and a monomeric unit such as ethylene oxide, propylene oxide, butylene oxide and mixtures thereof, preferably propylene oxide, ethylene oxide or mixed propylene oxide and ethylene oxide. The polyfunctional active hydrogen initiator preferably has a functionality of 2-8, and more preferably has a functionality of 3 or greater (e.g., 4-8).

A wide variety of initiators may be alkoxylated to form useful polyether polyols. Thus, for example, poly-functional amines and alcohols of the following type may be alkoxylated: monoethanolamine, diethanolamine, triethanolamine, ethylene glycol, polyethylene glycol, propylene glycol, hexanetriol, polypropylene glycol, glycerine, sorbitol, trimethylolpropane, pentaerythritol, sucrose and other carbohydrates. Such amines or alcohols may be reacted with the alkylene oxide(s) using techniques known to those skilled in the art. The hydroxyl number which is desired for the finished polyol would determine the amount of alkylene oxide used to react with the initiator. The polyether polyol may be prepared by reacting the initiator with a single alkylene oxide, or with two or more alkylene oxides added sequentially to give a block polymer chain or at once to achieve a random distribution of such alkylene oxides. Polyol blends such as a mixture of high molecular weight polyether polyols with lower molecular weight polyether polyols can also be employed.

The alkylene oxides which may be used in the preparation of the polyol include any compound having a cyclic ether group, preferably an α,β-oxirane, and are unsubstituted or alternatively substituted with inert groups which do not chemically react under the conditions encountered whilst preparing a polyol. Examples of suitable alkylene oxides include ethylene oxide, propylene oxide, 1,2- or 2,3-butylene oxide, the various isomers of hexane oxide, styrene oxide, epichlorohydrin, epoxychlorohexane, epoxychloropentane and the like. Most preferred, on the basis of performance, availability and cost are ethylene oxide, propylene oxide, butylene oxide and mixtures thereof, with ethylene oxide, propylene oxide, or mixtures thereof being most preferred. When polyols are prepared with combinations of alkylene oxides, the alkylene oxides may be reacted as a complete mixture providing a random distribution of oxyalkylene units within the oxide chain of the polyol or alternatively they may be reacted in a step-wise manner so as to provide a block distribution within the oxyalkylene chain of the polyol.

Such polyols include a sucrose-initiated polyol propoxylated to an average hydroxyl number of from 400 to 500, a sorbitol-initiated polyol propoxylated to an average hydroxyl number of 450 to 490, a sorbitol-glycerine initiated polyol having nominally an average of 4.0 to 4.4 active hydrogens and propoxylated to a hydroxyl number of 450 to 490.

Polyols of a higher hydroxyl number than 650 may be used as optional ingredients in the process of the present invention. Polyester polyols are particularly preferred. Suitable optional polyols include polyether polyols, polyester polyols, polyhydroxy-terminated acetal resins, hydroxy-terminated amines and polyamines. Examples of these and other suitable materials are described more fully in U.S. Pat. No. 4,394,491, which is incorporated in its entirety herein by reference thereto. Most preferred for preparing rigid foams are those having from 2 to 6 active hydrogens and having a hydroxyl number from 50 to 800, preferably from 200 to 650, and more preferably from 300 to 550. Examples of such polyols include those commercially available under the product names TERATE (available from KoSa) and MULTRANOL (available from Bayer) and STEPANOL (available from Stepan Co.).

Other components useful in producing the polyurethane foams in the present invention include those known in the art such as blowing agents, surfactants, catalysts, pigments, colorants, fillers, antioxidants, flame retardants, stabilizers, and the like.

Any suitable blowing agent can be employed in the foam compositions of the present invention. In general, these blowing agents are liquids having a boiling point between −50° C. and 100° C. and preferably between 0° C. and 50° C. The preferred liquids are hydrocarbons or halohydrocarbons such as chlorinated and fluorinated hydrocarbons. Suitable blowing agents include, but are not limited to, HCFC-141b (1-chloro-1,1-difluoroethane), HCFC-22 (monochlorodifluoromethane), HFC-245 fa (1,1,1,3,3-pentafluoropropane), HFC-134a (1,1,1,2-tetrafluoroethane), HFC-365mfc (1,1,1,3,3-pentafluorobutane), cyclopentane, normal pentane, isopentane, LBL-2(2-chloropropane), trichlorofluoromethane, CCl₂ FCClF₂, CCl₂ FCHF₂, trifluorochloropropane, 1-fluoro-1,1-dichloroethane, 1,1,1-trifluoro-2,2-dichloroethane, methylene chloride, diethylether, isopropyl ether, methyl formate, carbon dioxide and mixtures thereof.

The foams may also be produced using a froth-foaming method, such as that disclosed in U.S. Pat. No. 4,572,865, which is incorporated in its entirety herein by reference thereto, wherein the frothing agent can be any material which is inert to the reactive ingredients and is easily vaporized at atmospheric pressure. The frothing agent advantageously has an atmospheric boiling point of −50° to 10° C., and includes carbon dioxide, dichlorodifluoromethane, monochlorodifluoromethane, trifluoromethane, monochlorotrifluoromethane, monochloropentafluoroethane, vinylfluoride, vinylidenefluoride, 1,1-difluoroethane, 1,1,1-trichlorodifluoroethane, and the like. A higher boiling blowing agent is desirably used in conjunction with the frothing agent. The blowing agent is a gaseous material at the reaction temperature and advantageously has an atmospheric boiling point ranging from 10° to 80° C. Suitable blowing agents include trichloromonofluoromethane, 1,1,2-trichloro-1,2,2-trifluoroethane, acetone, pentane, and the like. In the froth-foaming method, the foaming agents, e.g., trichlorofluoromethane blowing agent or combined trichlorofluoromethane blowing agent and dichlorodifluoromethane frothing agent, are employed in an amount sufficient to give the resultant cured foam the desired bulk density which is generally between 0.5 and 10, preferably between 1 and 5, and most preferably between 1.5 and 2.5, pounds per cubic foot.

The foaming agents generally comprise from 1 to 30, and preferably comprise from 5 to 20 weight percent of the composition. When a foaming agent has a boiling point at or below ambient, it is maintained under pressure until mixed with the other components. Alternatively, it can be maintained at lower than ambient temperatures until mixed with the other components. Mixtures of foaming agents may be employed.

When preparing polyisocyanate-based foams, it is generally advantageous to employ a minor amount of a surfactant to stabilize the foaming reaction mixture until it obtains rigidity. Any suitable surfactant can be employed in the invention, including silicone/ethylene oxide/propylene oxide copolymers. Examples of surfactants useful in the present invention include, among others, polydimethylsiloxane-polyoxyalkylene block copolymers L-5420, L-5340, and Y10744 (available from Witco Corp.); DC-193 (from Air Products); and TEGOSTAB B84PI; and DABCO DC9141 (from Goldschmidt AG). Other suitable surfactants are described in U.S. Pat. Nos. 4,365,024 and 4,529,745. Other, less preferred surfactants include polyethylene glycol ethers of long chain alcohols, tertiary amine or alkanolamine salts of long chain alkyl acid sulfate esters, alkylsulfonic esters, alkylarylsulfonic acids. Such surfactants are employed in amounts sufficient to stabilize the foaming reaction mixture against collapse and the formation of large, and uneven cells. Generally, the surfactant comprises from 0.05 to 10, and preferably from 0.1 to 6, weight percent of the foam-forming composition.

One or more catalysts may be advantageously used. Any suitable urethane catalyst may be used including the known tertiary amine compounds and organometallic compounds. Examples of suitable tertiary amine catalysts include triethylenediamine, N-methylmorpholine, pentamethyl diethylenetriamine, dimethylcyclohexylamine, tetramethylethylenediamine, 1-methyl-4-dimethylaminoethyl-piperazine, 3-methoxy-N-dimethyl-propylamine, N-ethylmorpholine, diethylethanolamine, N-cocomorpholine, N,N-dimethyl-N′,N′ dimethylisopropyl-propylene diamine, N,N-diethyl-3-diethyl aminopropyl amine and dimethyl-benzyl amine. Examples of suitable organometallic catalysts include organomercury, organolead, organoferric and organotin catalysts, with organotin catalysts being preferred. Suitable organotin catalysts include tin salts of carboxylic acids such as dibutyltin di-2-ethyl hexanoate and dibutyltin dilaurate. Metal salts such as stannous chloride can also function as catalysts for the urethane reaction. A catalyst for the trimerization of polyisocyanates, such as an alkali metal alkoxide or carboxylate, may also optionally be employed herein. Such catalysts are used in an amount which measurably increases the rate of reaction of the polyisocyanate. Typical amounts are 0.01 to 5.0 part of catalyst per 100 parts by weight of polyol.

The components described may be employed to produce rigid polyurethane and polyurethane-modified isocyanurate foam. The rigid foams produced in the present invention may be made in a one-step process by reacting all of the ingredients together at once, or foams can be made by the so-called “quasi prepolymer” method. In the one-shot process, the active hydrogen containing compounds, catalyst, surfactants, blowing agents and optional additives may be introduced separately to the mixing head where they are combined with the polyisocyanate to give the polyurethane-forming mixture. For use of machines with a limited number of component lines into the mixing head, a premix of all the components except the polyisocyanate can be advantageously employed. This simplifies the metering and mixing of the reacting components at the time the polyurethane-forming mixture is prepared.

Alternatively, the foams may be prepared by the so-called “quasi prepolymer” method. In this method, a portion of the polyol component is reacted in the absence of catalysts with the polyisocyanate component in proportion so as to provide from 10 percent to 30 percent of free isocyanate groups in the reaction product based on the prepolymer. To prepare foam, the remaining portion of the polyol is added and the components are allowed to react together in the presence of catalysts and other appropriate additives such as blowing agent, surfactant, etc. Other additives may be added to either the prepolymer or remaining polyol or both prior to the mixing of the components, whereby at the end of the reaction a rigid polyurethane foam is provided.

Facings for use in the present invention include any flat, sheet material suitable to the required end application of the final board product. Such materials include aluminum foil/Kraft paper laminations, bare aluminum foil, paper roof insulation facings, and coated glass fiber mats. A facer, as used herein, may also include oriented strandboard or gypsum, in which case such rigid material is conveyed to the laminator, and foam-forming mixture is preferably applied directly thereon.

The rigid polyurethane foams produced by the inventive process are useful in a wide range of applications including, but not limited to, roofing, sheathing, metal panels such as used in garage doors and the like. Spray insulation rigid insulating board stock, laminates and many other types of rigid foam can easily be prepared according to the process of this invention.

### EXAMPLES

The present invention is further illustrated, but is not to be limited, by the following examples.

### Comparative Example 1

A 2-inch (5.08 cm) rigid polyurethane roofing board was made using standard multi-stream techniques. Processing conditions were as follows: a 75-foot (22.86 m) laminator (Hennecke Machinery Co.) with a multi-stream spray head having 3-4 streams per head was run at a laminator temperature of 160° F. (71.1° C.), a chemical temperature of 80° F. (26.7° C.), a chemical output per head of 85 lb/min. (38.5 kg/min.) and a calculated line speed 150 ft/min. (45.72 m/min.) [the actual line speed was 145 ft/min. (44.2 m/min.)]. The polyurethane formulation used was made according to the following Table I.

TABLE I

| Poly blend | PBW | Isocyanate | PBW |
|---|---|---|---|
| Polyester polyol | 100 | MDI (MONDUR-489) | 170 |
| Fire Retardant | 15 | | |
| Amine Catalyst | 0.5 | | |
| Trimerization Catalyst | 6.0 | | |
| Silicone Surfactant | 2.5 | | |
| Water | 0.5 | | |
| Pentane | 20 | | |
| Poly blend total | 144.5 | Isocyanate total | 170 |

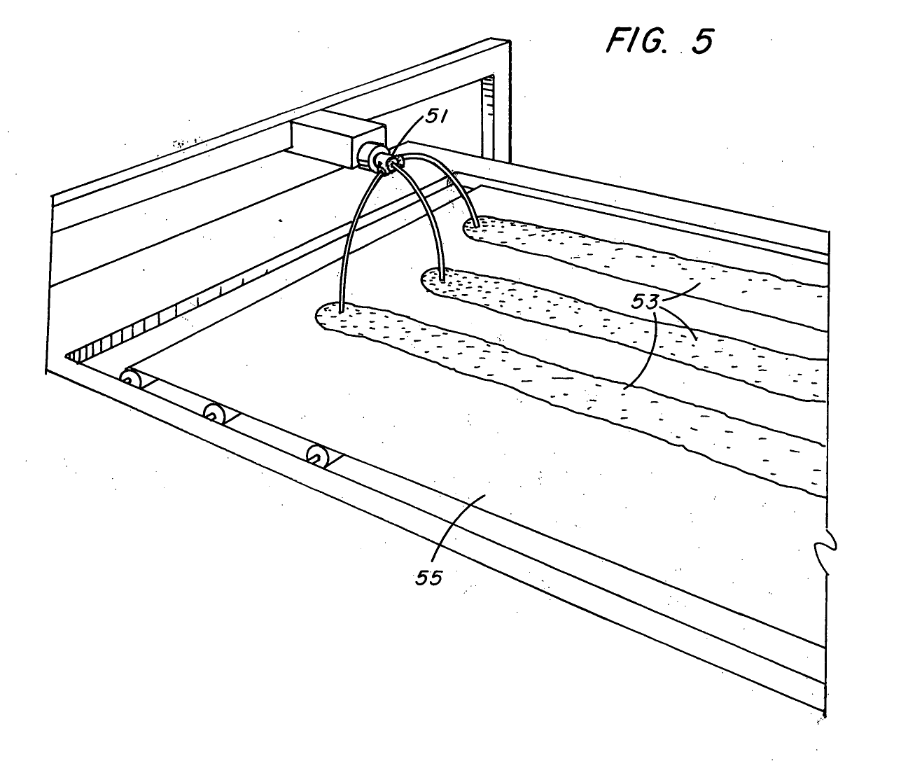

FIG. 5 illustrates the standard multi-stream process. Multi-stream mixhead 51 deposits liquid foam streams 53 onto conveyor belt 55. As appreciated by reference to FIG. 5, substantially full liquid wet out is difficult if not impossible to achieve in this process. A cross section was taken through two boards made by the standard multi-stream process and the irregularly-shaped cells oriented in different directions in the foam can be seen in FIGS. 1a and 1b.

### Example 2

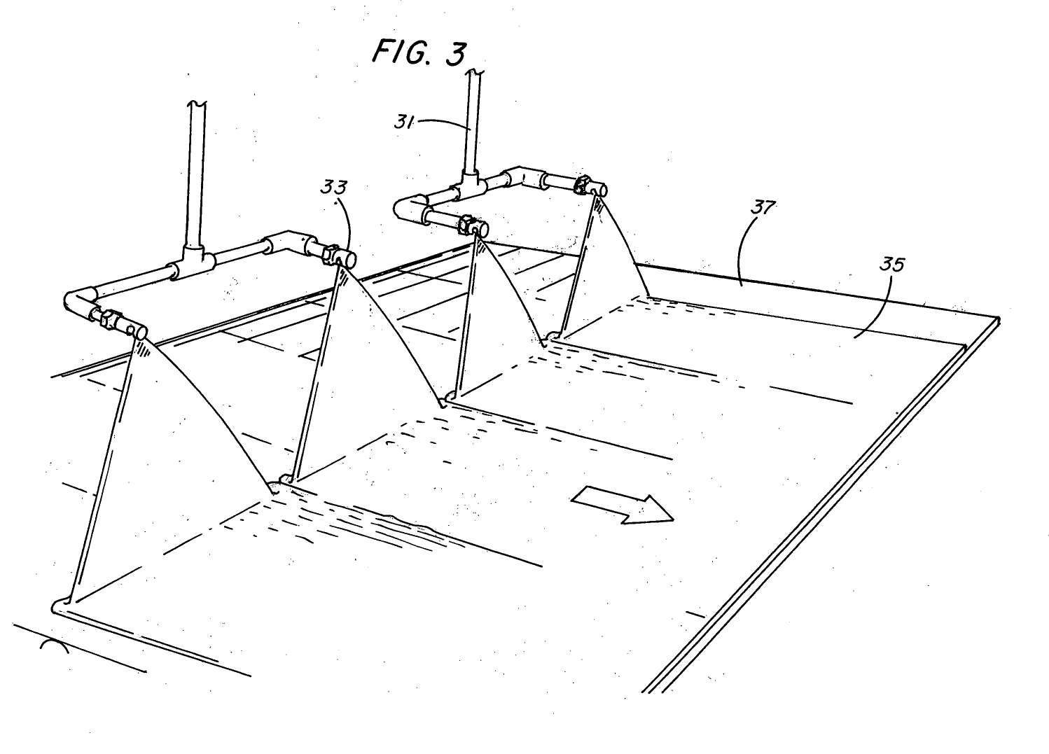

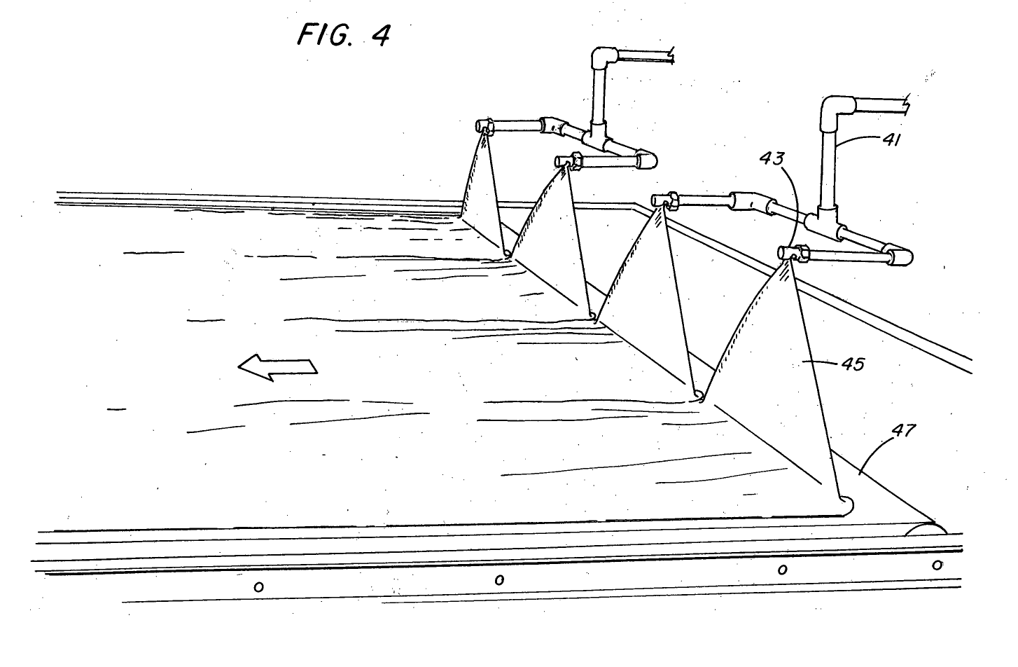

The procedure described above was repeated except ½″×90 fan tips (available from Spraying Systems Co as FLOODJET flat spray nozzles), were used instead of the standard multi-stream spray. The flat spray nozzles were arranged over the conveyor belt so as to achieve substantially full liquid wet-out (i.e., greater than 95%) of the foam chemicals as shown in FIGS. 3 and 4.

FIGS. 3 and 4 illustrate the present invention. By reference to FIG. 3, the polyurethane liquid foam formulation is pumped from the mixhead (not shown) through pipe 31 into flat spray nozzle 33. The formulation exits spray nozzle 33 and is deposited onto conveyor belt 37 as liquid foam 35.

FIG. 4 depicts the inventive process from another perspective. The polyurethane formulation is pumped from the mixhead (not shown) through pipe 41 into flat spray nozzle 43. The formulation exits spray nozzle 43 as liquid foam stream 45 onto conveyor belt 47.

As can be appreciated by reference to FIGS. 3 and 4, substantially full liquid wet out occurs in the inventive process. The substantially regular, circular-shaped cells produced in the foam by the present invention can be seen in FIGS. 2a and 2b, which are micrographs of cross sections taken through the foams produced according to the invention.

### Comparative Example 3

The procedure of Comparative Example 1 was repeated to make a 2.8-inch (7.1 cm) roofing board using the same multi-stream head. The output of the chemical was the same but because of the increased thickness, the line speed was reduced to a calculated speed of 100′ ft/min. (30.5 m/min.).

### Example 4

The procedure described above in Comparative Example 3 was repeated using ½″×120 fan tips instead of the standard multi-stream spray nozzles.

Tables II and III summarize the results of the above-detailed examples. Testing was done under the Standard specification for Faced Rigid Cellular Polyisocyanurate Thermal Insulation Board. ASTM Designation C 1289-02

Standard ASTM Methods used were as follows;

D1622—Apparent density of rigid cell
D1621—Compressive properties
D6226—Open cell content
D2126—Dimensional stability
C518-98—Thermal conductivity with a LASERCOMP FOX 200 instrument—heat flow method.

K-factor is the rate of transfer of heat through one square foot of one inch thick material in one hour where there is a difference of one degree Fahrenheit perpendicularly across the two surfaces of the material.

The cell size determination was via digital image analysis using a test developed for rigid foam by Bayer.

TABLE II

| | Example | | | | | | | |
|---|---|---|---|---|---|---|---|---|
| | C1 | | | | 2 | | | |
| Physical Properties | Left | Center | Right | | Left | Center | Right | |
| Core Density (pcf) | 1.69 | 1.71 | 1.68 | | 1.68 | 1.68 | 1.68 | |
| Comp. Strength, 10% = | 32.14 | 31.02 | 30.74 | | 28.19 | 32.1 | 31.09 | |
| Comp. Strength, 10% + | 25.39 | 25.02 | 25.26 | | 24.91 | 24.66 | 26.89 | |
| Percent Open Cells | | 9.5 | | | | 9.6 | | |
| Percent Closed Cells | | 88.2 | | | | 88.1 | | |
| Initial k-Factor | | 0.163 | | | | 0.162 | | |
| Foam cell size | | 132 | | | | 130 | | |
| (average cell diameter (μm)) | | | | | | | | |
| 7-Day Dimensional Stability | | | | | | | | |
| (percent average change) at | Length | Width | Thickness | Volume | Length | Width | Thickness | Volume |
| 70° C./95% relative humidity | 0.5 | 1 | 1.3 | 2.9 | 0.9 | 0.4 | 1 | 2.2 |
| 100° C./ambient relative humidity | −0.1 | 0 | −0.4 | −0.5 | 0 | 0 | 1.2 | 1.3 |
| −30° C./ambient relative humidity | −0.1 | 0 | 0.3 | 0.2 | 0 | −0.1 | 1.6 | 1.5 |

TABLE III

| | Example No. | | | | | | | |
|---|---|---|---|---|---|---|---|---|
| | C3 | | | | 4 | | | |
| Physical Properties | Left | Center | Right | | Left | Center | Right | |
| Core Density (pcf) | | | | | | | | |
| Comp. Strength, 10% = | 28.12 | 26.79 | 25.31 | | 26.99 | 28.76 | 31.4 | |
| Comp. Strength, 10% + | 20.7 | 23.59 | 19.87 | | 21.34 | 22.01 | 21.54 | |
| Percent Open Cells | | 11.1 | | | | 11.1 | | |
| Percent Closed Cells | | 86.8 | | | | 86.8 | | |
| Initial k-Factor | | 0.163 | | | | 0.162 | | |
| Foam cell size | | 139 | | | | 128 | | |
| (average cell diameter (μm)) | | | | | | | | |
| 7-Day Dimensional Stability | | | | | | | | |
| (percent average change) at | Length | Width | Thickness | Volume | Length | Width | Thickness | Volume |
| 70° C./95% relative humidity | 0.2 | 0.7 | 1.7 | 2.6 | 0.7 | 0.2 | 2.3 | 3.2 |
| 100° C./ambient relative humidity | −0.1 | −0.3 | 0.4 | 0 | −0.2 | −0.4 | −0.4 | −1 |
| −30° C./ambient relative humidity | −0.1 | −0.2 | 0.4 | 0.1 | −0.2 | −0.2 | 0.3 | −0.1 |

As is apparent by reference to Tables II and III, somewhat better foam utilization is achieved with the fan tips as compared to the standard production board. There is little or no variation in the core densities and initial k factors of the foams made according to the invention versus those foams made by the standard process. Further, there is less variation in length and width over time in the foams made according to the instant invention.

The foregoing examples of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

1. A process of producing a rigid polyurethane foam comprising spraying a mixture comprising at least one isocyanate and at least one isocyanate reactive compound onto a supporting surface through a plurality of flat spray nozzles arranged over the supporting surface such that foam cells in the rigid polyurethane foam have substantially uniform dimensional stability and compressive strength throughout the foam.

2. The process according to claim 1, wherein the at least one isocyanate is chosen from aromatic polyisocyanates, aliphatic polyisocyanates, cycloaliphatic polyisocyanates and combinations thereof.

3. The process according to claim 1, wherein the at least one isocyanate is chosen from m-phenylene diisocyanate, toluene-2,4-diisocyanate, toluene-2,6-diisocyanate, mixtures of 2,4- and 2,6-toluene diisocyanate, hexamethylene-1,6-diisocyanate, tetramethylene-1,4-diisocyanate, cyclohexane-1,4-diisocyanate, hexahydrotoluene 2,4- and 2,6-diisocyanate, naphthalene-1,5-diisocyanate, diphenyl methane-4,4′-diisocyanate, 4,4′-diphenylenediisocyanate, 3,3′-dimethoxy-4,4′-biphenyl-diisocyanate, 3,3′-dimethyldiphenylmethane-4,4′-diisocyanate; 4,4′,4′-triphenylmethane-triisocyanate, polymethylenepolyphenyl isocyanate, toluene-2,4,6-triisocyanate and 4,4′-dimethyldiphenylmethane-2,2′,5,5′-tetraisocyanate.

4. The process according to claim 1, wherein the at least one isocyanate reactive compound is chosen from polyester and polyether polyols containing at least two isocyanate-reactive hydrogen atoms and having a hydroxyl (OH) number of from about 200 to about 650.

5. The process according to claim 1, wherein the at least one isocyanate reactive compound is a polyester polyol comprising a polycarboxylic acid or acid derivative and a polyhydric alcohol.

6. The process according to claim 5, wherein the polycarboxylic acid is chosen from oxalic acid, malonic acid, succinic acid, glutaric acid, adipic acid, pimelic acid, suberic acid, azelaic acid, sebacic acid, phthalic acid, isophthalic acid, trimellitic acid, terephthalic acid, phthalic acid anhydride, tetrahydrophthalic acid anhydride, pyromellitic dianhydride, hexahydrophthalic acid anhydride, tetrachlorophthalic acid anhydride, endomethylene tetrahydrophthalic acid anhydride, glutaric acid anhydride, maleic acid, maleic acid anhydride, fumaric acid and dibasic and tribasic unsaturated fatty acids optionally mixed with monobasic unsaturated fatty acids.

7. The process according to claim 5, wherein the polyhydric alcohol is chosen from ethylene glycol, propylene glycol-(1,2) and -(1,3), butylene glycol-(1,4) and -(2,3), hexane diol-(1,6), octane diol-(1,8), neopentyl glycol, 1,4-bis-hydroxymethyl cyclohexane, 2-methyl-1,3-propane diol, glycerin, trimethylolpropane, trimethylolethane, hexane triol-(1,2,6), butane triol-(1,2,4), pentaerythritol, quinitol, mannitol, sorbitol, formitol, α-methyl-glucoside, diethylene glycol, triethylene glycol, tetraethylene glycol, dipropylene glycol and dibutylene glycol.

8. The process according to claim 1, wherein the at least one isocyanate reactive compound is a polyether polyol comprising the reaction product of a polyfunctional active hydrogen initiator and an alkylene oxide.

9. The process according to claim 8, wherein the polyfunctional active hydrogen initiator is chosen from monoethanolamine, diethanolamine, triethanolamine, ethylene glycol, polyethylene glycol, propylene glycol, hexanetriol, polypropylene glycol, glycerine, sorbitol, trimethylolpropane, pentaerythritol and sucrose.

10. The process according to claim 8, wherein the alkylene oxide is chosen from ethylene oxide, propylene oxide, 1,2- or 2,3-butylene oxide, isomers of hexane oxide, styrene oxide, epichlorohydrin, epoxychlorohexane and epoxychloropentane.

11. The process according to claim 1, wherein the mixture further includes at least one of a blowing agent, surfactant, catalyst, pigment, colorant, filler, antioxidant, flame retardant and stabilizer.

12. The process according to claim 11, wherein the blowing agent is chosen from 1-chloro-1,1-difluoroethane (HCFC-141b), monochlorodifluoromethane (HCFC-22), 1,1,1,3,3-pentafluoropropane (HFC-245 fa), 1,1,1,2-tetrafluoroethane (HFC-134a), 1,1,1,3,3-pentafluorobutane (HFC-365mfc), cyclopentane, normal pentane, isopentane, 2-chloropropane (LBL-2), trichlorofluoromethane, CCl₂ FCClF₂, CCl₂ FCHF₂, trifluorochloropropane, 1-fluoro-1,1-dichloroethane, 1,1,1-trifluoro-2,2-dichloroethane, methylene chloride, diethylether, isopropyl ether, methyl formate, carbon dioxide and mixtures thereof.

13. The process according to claim 1, wherein the plurality of flat spray nozzles comprises four to eight nozzles.

14. The process according to claim 1, wherein the supporting surface is a conveyor belt.

15. The process according to claim 1, wherein at least one facer is disposed on the supporting surface.

16. The process according to claim 15, wherein the facer is chosen from aluminum foil/Kraft paper laminations, bare aluminum foil, paper roof insulation facings, coated glass fiber mats, oriented strandboard and gypsum.

17. The process according to claim 1, wherein the foam cells are substantially circular-shaped.

18. In one of a roofing panel, a sheathing panel and a garage door panel, the improvement comprising including the rigid polyurethane foam made by the process according to claim 1.

19. A process of producing a rigid polyurethane foam comprising spraying a mixture comprising at least one isocyanate and at least one isocyanate reactive compound onto a supporting surface through a plurality of flat spray nozzles arranged over the supporting surface such that substantially full liquid wet out of the mixture occurs on the supporting surface.

20. The process according to claim 19, wherein the at least one isocyanate is chosen from aromatic polyisocyanates, aliphatic polyisocyanates, cycloaliphatic polyisocyanates and combinations thereof.

21. The process according to claim 19, wherein the at least one isocyanate is chosen from m-phenylene diisocyanate, toluene-2,4-diisocyanate, toluene-2,6-diisocyanate, mixtures of 2,4- and 2,6-toluene diisocyanate, hexamethylene-1,6-diisocyanate, tetramethylene-1,4-diisocyanate, cyclohexane-1,4-diisocyanate, hexahydrotoluene 2,4- and 2,6-diisocyanate, naphthalene-1,5-diisocyanate, diphenyl methane-4,4′-diisocyanate, 4,4′-diphenylenediisocyanate, 3,3′-dimethoxy-4,4′-biphenyl-diisocyanate, 3,3′-dimethyldiphenylmethane-4,4′-diisocyanate; 4,4′,4′-triphenylmethane-triisocyanate, polymethylenepolyphenyl isocyanate, toluene-2,4,6-triisocyanate and 4,4′-dimethyldiphenylmethane-2,2′,5,5′-tetraisocyanate.

22. The process according to claim 19, wherein the at least one isocyanate reactive compound is chosen from polyester and polyether polyols containing at least two isocyanate-reactive hydrogen atoms and having a hydroxyl (OH) number of from about 200 to about 650.

23. The process according to claim 19, wherein the at least one isocyanate reactive compound is a polyester polyol comprising a polycarboxylic acid or acid derivative and a polyhydric alcohol.

24. The process according to claim 23, wherein the polycarboxylic acid is chosen from oxalic acid, malonic acid, succinic acid, glutaric acid, adipic acid, pimelic acid, suberic acid, azelaic acid, sebacic acid, phthalic acid, isophthalic acid, trimellitic acid, terephthalic acid, phthalic acid anhydride, tetrahydrophthalic acid anhydride, pyromellitic dianhydride, hexahydrophthalic acid anhydride, tetrachlorophthalic acid anhydride, endomethylene tetrahydrophthalic acid anhydride, glutaric acid anhydride, maleic acid, maleic acid anhydride, fumaric acid and dibasic and tribasic unsaturated fatty acids optionally mixed with monobasic unsaturated fatty acids.

25. The process according to claim 23, wherein the polyhydric alcohol is chosen from ethylene glycol, propylene glycol-(1,2) and -(1,3), butylene glycol-(1,4) and -(2,3), hexane diol-(1,6), octane diol-(1,8), neopentyl glycol, 1,4-bis-hydroxymethyl cyclohexane, 2-methyl-1,3-propane diol, glycerin, trimethylolpropane, trimethylolethane, hexane triol-(1,2,6), butane triol-(1,2,4), pentaerythritol, quinitol, mannitol, sorbitol, formitol, α-methyl-glucoside, diethylene glycol, triethylene glycol, tetraethylene glycol, dipropylene glycol and dibutylene glycol.

26. The process according to claim 19, wherein the at least one isocyanate reactive compound is a polyether polyol comprising the reaction product of a polyfunctional active hydrogen initiator and an alkylene oxide.

27. The process according to claim 26, wherein the polyfunctional active hydrogen initiator is chosen from monoethanolamine, diethanolamine, triethanolamine, ethylene glycol, polyethylene glycol, propylene glycol, hexanetriol, polypropylene glycol, glycerine, sorbitol, trimethylolpropane, pentaerythritol and sucrose.

28. The process according to claim 26, wherein the alkylene oxide is chosen from ethylene oxide, propylene oxide, 1,2- or 2,3-butylene oxide, isomers of hexane oxide, styrene oxide, epichlorohydrin, epoxychlorohexane and epoxychloropentane.

29. The process according to claim 19, wherein the mixture further includes at least one of a blowing agent, surfactant, catalyst, pigment, colorant, filler, antioxidant, flame retardant and stabilizer.

30. The process according to claim 29, wherein the blowing agent is chosen from 1-chloro-1,1-difluoroethane (HCFC-141b), monochlorodifluoromethane (HCFC-22), 1,1,1,3,3-pentafluoropropane (HFC-245 fa), 1,1,1,2-tetrafluoroethane (HFC-134a), 1,1,1,3,3-pentafluorobutane (HFC-365mfc), cyclopentane, normal pentane, isopentane, 2-chloropropane (LBL-2), trichlorofluoromethane, CCl₂ FCClF₂, CCl₂ FCHF₂, trifluorochloropropane, 1-fluoro-1,1-dichloroethane, 1,1,1-trifluoro-2,2-dichloroethane, methylene chloride, diethylether, isopropyl ether, methyl formate, carbon dioxide and mixtures thereof.

31. The process according to claim 19, wherein the plurality of flat spray nozzles comprises four to eight nozzles.

32. The process according to claim 19, wherein the supporting surface is a conveyor belt.

33. The process according to claim 19, wherein at least one facer is disposed on the supporting surface.

34. The process according to claim 33, wherein the facer is chosen from aluminum foil/Kraft paper laminations, bare aluminum foil, paper roof insulation facings, coated glass fiber mats, oriented strandboard and gypsum.

35. The process according to claim 19, wherein the foam cells are substantially circular-shaped.

36. In one of a roofing panel, a sheathing panel and a garage door panel, the improvement comprising including the rigid polyurethane foam made by the process according to claim 19.

37. A polyurethane foam producing apparatus comprising:
a plurality of flat spray nozzles;
one or more mix heads;
a plurality of reservoirs, at least one of which contains an isocyanate and at least another one of which contains an isocyanate reactive compound; and
a supporting surface,
wherein the plurality of flat spray nozzles are connected to the one or more mix heads which are connected to the plurality of reservoirs and the plurality of flat spray nozzles are arranged over the supporting surface such that substantially full liquid wet-out occurs during polyurethane foam production.

38. The apparatus according to claim 37, wherein the plurality of flat spray nozzles comprises four to eight nozzles.

39. The apparatus according to claim 37, wherein the supporting surface is a conveyor belt.

40. A rigid polyurethane foam produced by spraying a mixture comprising at least one isocyanate and at least one isocyanate reactive compound onto a supporting surface through a plurality of flat spray nozzles arranged over the supporting surface such that foam cells in the rigid polyurethane foam have substantially uniform dimensional stability and compressive strength throughout the foam.

41. The rigid polyurethane foam according to claim 40, wherein the at least one isocyanate is chosen from aromatic polyisocyanates, aliphatic polyisocyanates, cycloaliphatic polyisocyanates and combinations thereof.

42. The rigid polyurethane foam according to claim 40, wherein the at least one isocyanate is chosen from m-phenylene diisocyanate, toluene-2,4-diisocyanate, toluene-2,6-diisocyanate, mixtures of 2,4- and 2,6-toluene diisocyanate, hexamethylene-1,6-diisocyanate, tetramethylene-1,4-diisocyanate, cyclohexane-1,4-diisocyanate, hexahydrotoluene 2,4- and 2,6-diisocyanate, naphthalene-1,5-diisocyanate, diphenyl methane-4,4′-diisocyanate, 4,4′-diphenylenediisocyanate, 3,3′-dimethoxy-4,4′-biphenyl-diisocyanate, 3,3′-dimethyldiphenylmethane-4,4′-diisocyanate; 4,4′,4′-triphenylmethane-triisocyanate, polymethylenepolyphenyl isocyanate, toluene-2,4,6-triisocyanate and 4,4′-dimethyldiphenylmethane-2,2′,5,5′-tetraisocyanate.

43. The rigid polyurethane foam according to claim 40, wherein the at least one isocyanate reactive compound is chosen from polyester and polyether polyols containing at least two isocyanate-reactive hydrogen atoms and having a hydroxyl (OH) number of from about 200 to about 650.

44. The rigid polyurethane foam according to claim 40, wherein the at least one isocyanate reactive compound is a polyester polyol comprising a polycarboxylic acid or acid derivative and a polyhydric alcohol.

45. The rigid polyurethane foam according to claim 44, wherein the polycarboxylic acid is chosen from oxalic acid, malonic acid, succinic acid, glutaric acid, adipic acid, pimelic acid, suberic acid, azelaic acid, sebacic acid, phthalic acid, isophthalic acid, trimellitic acid, terephthalic acid, phthalic acid anhydride, tetrahydrophthalic acid anhydride, pyromellitic dianhydride, hexahydrophthalic acid anhydride, tetrachlorophthalic acid anhydride, endomethylene tetrahydrophthalic acid anhydride, glutaric acid anhydride, maleic acid, maleic acid anhydride, fumaric acid and dibasic and tribasic unsaturated fatty acids optionally mixed with monobasic unsaturated fatty acids.

46. The rigid polyurethane foam according to claim 44, wherein the polyhydric alcohol is chosen from ethylene glycol, propylene glycol-(1,2) and -(1,3), butylene glycol-(1,4) and -(2,3), hexane diol-(1,6), octane diol-(1,8), neopentyl glycol, 1,4-bis-hydroxymethyl cyclohexane, 2-methyl-1,3-propane diol, glycerin, trimethylolpropane, trimethylolethane, hexane triol-(1,2,6), butane triol-(1,2,4), pentaerythritol, quinitol, mannitol, sorbitol, formitol, α-methyl-glucoside, diethylene glycol, triethylene glycol, tetraethylene glycol, dipropylene glycol and dibutylene glycol.

47. The rigid polyurethane foam according to claim 40, wherein the at least one isocyanate reactive compound is a polyether polyol comprising the reaction product of a polyfunctional active hydrogen initiator and an alkylene oxide.

48. The rigid polyurethane foam according to claim 47, wherein the polyfunctional active hydrogen initiator is chosen from monoethanolamine, diethanolamine, triethanolamine, ethylene glycol, polyethylene glycol, propylene glycol, hexanetriol, polypropylene glycol, glycerine, sorbitol, trimethylolpropane, pentaerythritol and sucrose.

49. The rigid polyurethane foam according to claim 47, wherein the alkylene oxide is chosen from ethylene oxide, propylene oxide, 1,2- or 2,3-butylene oxide, isomers of hexane oxide, styrene oxide, epichlorohydrin, epoxychlorohexane and epoxychloropentane.

50. The rigid polyurethane foam according to claim 40, wherein the mixture further includes at least one of a blowing agent, surfactant, catalyst, pigment, colorant, filler, antioxidant, flame retardant and stabilizer.

51. The rigid polyurethane foam according to claim 50, wherein the blowing agent is chosen from 1-chloro-1,1-difluoroethane (HCFC-141b), monochlorodifluoromethane (HCFC-22), 1,1,1,3,3-pentafluoropropane (HFC-245 fa), 1,1,1,2-tetrafluoroethane (HFC-134a), 1,1,1,3,3-pentafluorobutane (HFC-365mfc), cyclopentane, normal pentane, isopentane, 2-chloropropane (LBL-2), trichlorofluoromethane, CCl₂ FCClF₂, CCl₂ FCHF₂, trifluorochloropropane, 1-fluoro-1,1-dichloroethane, 1,1,1-trifluoro-2,2-dichloroethane, methylene chloride, diethylether, isopropyl ether, methyl formate, carbon dioxide and mixtures thereof.

52. The rigid polyurethane foam according to claim 40, wherein the foam cells are substantially circular-shaped.

53. The rigid polyurethane foam according to claim 40, wherein at least one facer is disposed on the supporting surface.

54. The rigid polyurethane foam according to claim 40, wherein the facer is chosen from aluminum foil/Kraft paper laminations, bare aluminum foil, paper roof insulation facings, coated glass fiber mats, oriented strandboard and gypsum.

55. In one of a roofing panel, a sheathing panel and a garage door panel, the improvement comprising including the rigid polyurethane foam according to claim 40.
